(19) United States
(12) Patent Application Publication
(10) Pub. No.: US 2009/0324398 A1
(43) Pub. Date: Dec. 31, 2009

(54) DEVICE FOR CARRYING OUT AN INDUCTIVE LOW-FREQUENCY OR HIGH-FREQUENCY PRESSURE WELDING METHOD, COMPRISING AN INSULATOR LOCATED BETWEEN THE INDUCTOR AND THE COMPONENTS IN THE ZONE OF THE JOINT

(76) Inventors: Herbert Hanrieder, Hohenkammer (DE); Alexander Gindorf, Schwabhausen (DE)

Correspondence Address: GREER, BURNS & CRAIN, 300 S WACKER DR, 25TH FLOOR, CHICAGO, IL, 60606, US

(21) Appl. No.: 12/302,205

(22) PCT Filed: May 18, 2007
(86) PCT No.: PCT/DE07/00917

§ 371 Date: Aug. 20, 2009

(30) Foreign Application Priority Data
May 24, 2006 (DE) 10 2006 024 283.1

(51) Int. Cl. F03B 3/12; B23K 13/01

(52) U.S. Cl. 415/182.1; 219/617; 416/223 R

(57) ABSTRACT

A device for carrying out an inductive low-frequency or high-frequency pressure welding method for joining metallic components, in particular components of a gas turbine, having at least one generator and at least one inductor, wherein an insulator is situated at least partly between the inductor and the components, in the area of the sections that are to be joined of the components, the insulator being made of a material that, due to its specific properties, does not, or does not significantly, prevent the magnetic interaction between the inductor and the components that are to be joined, and the insulator being situated at a distance from the inductor and the components, and that the insulator is made of high-temperature-resistant quartz glass.

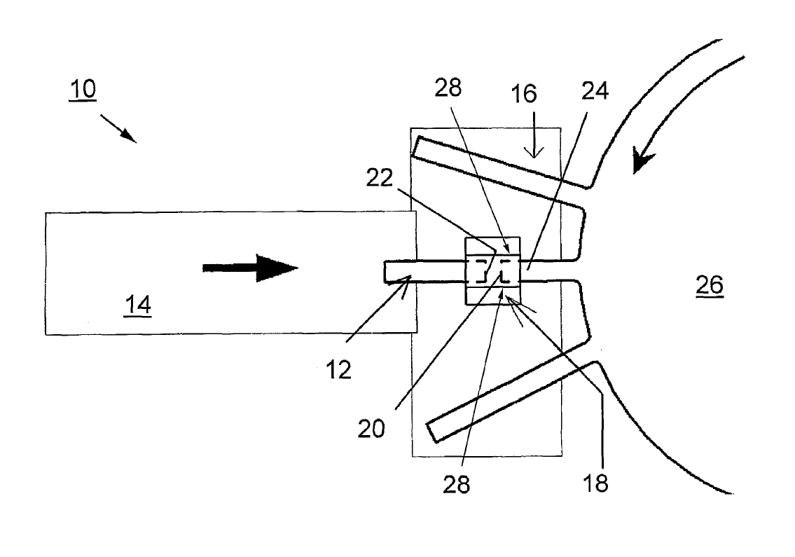

The present invention relates to a device for carrying out an inductive low-frequency or high-frequency pressure welding method for joining metallic components, in particular components of a gas turbine, having at least one generator and at least one inductor.

From the prior art, various devices and methods are known for joining metallic components using various pressure welding methods. Thus, for example, DE 10 2004 006 154 A1 and DE 10 2004 012 653 A1 each describe rotational friction welding methods for joining dynamically loaded components, in particular gas turbine components. The described friction welding is one of the named pressure welding methods; within friction welding methods, linear friction welding is distinguished from rotational friction welding and from what is known as friction stir welding.

From DE 198 58 702 A1, another pressure welding method is known for joining blade parts of a gas turbine, in which a blade leaf segment and at least one additional blade part are provided. Here, corresponding connecting surfaces of these elements are positioned at a distance from one another, essentially in alignment with each other, and are then welded to one another through the excitation of an inductor with high-frequency current, bringing the parts together so that their connecting surfaces contact each other. In this inductive high-frequency pressure welding, sufficiently high and homogenous heating of the two parts being welded to each other is of decisive importance for the quality of the join.

However, a disadvantage of the known devices for carrying out an inductive pressure welding method is that given larger component cross-sections, due to the concentrated introduction of a large quantity of energy vaporization of the metal can occur at the surface of the components that are to be joined, leading to subsequent plasma formation and a short-circuit to the inductor. This creates a disturbance in the continuity of the process controlling, and must be reliably prevented.

Therefore, the object of the present invention is to provide a device of the type indicated for carrying out an inductive low-frequency or high-frequency pressure welding method for joining metallic components, in which a continuous process controlling is ensured even given metal vapor formation at the surface of the components that are to be joined.

This object is achieved by a device having the features of Claim 1.

Advantageous constructions of the present invention are described in the subclaims.

A device according to the present invention for carrying out an inductive low-frequency or high-frequency pressure welding method for joining metallic components, in particular components of a gas turbine, has at least one generator and at least one inductor. According to the present invention, an insulator is situated at least partially between the inductor and the components in the area of the sections of the components that are to be joined, the insulator being made of a material that, due to its specific properties, does not, or does not significantly, prevent magnetic interaction between the inductor and the components that are to be joined. In addition, the insulator is formed at a distance from the inductor and from the components. Due to the insulating effect of the insulator, as well as the fact that the insulator is situated at a distance from the components and from the inductor, or from a corresponding inductor coil, it is ensured that no tension will occur between the inductor and the insulator due to possible temperature-dependent differences in the thermal expansion between the inductor and the insulator. In addition, if metal vapor results from vaporization of the surfaces of the components to be joined, the inductor remains reliably insulated, no plasma arises, and therefore no short-circuit occurs between the components and the inductor. Advantageously, the process can also take place without disturbance and continuously even given formation of metal vapor, which is absolutely necessary for example in automated series production of components. In addition, according to the present invention the magnetic interaction between the insulator and the components is not prevented, due to suitable selection of the material of the insulator.

In another advantageous construction of the present invention, the insulator can be fashioned in the form of a layer or film. The insulator is standardly made of glass, in particular high-temperature-resistant quartz glass, a high-temperature-resistance ceramic, or a high-temperature-resistant plastic. However, other materials having the named characteristics are also conceivable for the manufacture of the insulator.

In an advantageous construction of the device according to the present invention, the invention has means that enable the inductive low-frequency or high-frequency pressure welding to be carried out in a vacuum or in a protective gas atmosphere. Advantageously, this contributes to bringing it about that no gases are permitted to remain in the connecting surface or surfaces of the components. This has a positive effect on the quality of the resulting connection.

In another advantageous construction of the device according to the present invention, the frequencies used in the inductive low-frequency or high-frequency pressure welding are selected from a range between 0.05-2.5 MHz. Surprisingly, it has turned out that, in addition to the known high frequencies, frequencies in the range below 0.25 MHz are also sufficient to achieve sufficient heating in the context of frequency pressure welding, with the concomitant fusing of the connecting surface or surfaces. In addition, it is possible for different frequencies to act simultaneously or successively on the at least one connecting surface. With this multi-frequency technique, it is possible to take into account different compositions and shapes of the metallic components that are to be joined, and to achieve a maximally homogenous heating or fusing of the connecting surface or surfaces.

In another advantageous construction of the device according to the present invention, the first component is a blade of a rotor in a gas turbine, or a part thereof, and the second component is a ring or a disk of the rotor, or a blade foot situated on the periphery of the ring or of the disk. These parts, assembled from the named components, are what are known as BLINGs (bladed rings) or BLISKs (bladed disks) of gas turbine engines.

Additional advantages, features, and details of the present invention result from the following description of a graphically represented exemplary embodiment. The FIGURE shows a schematic representation of a device according to the present invention.

Device 10 is made up of a generator 16 for producing the required welding energy and an inductor 18, in particular an induction coil 18. Excitation of inductor 18 with high-frequency current heats connecting surfaces 20, 22 of components 12, 24. The heating takes place up to a point that is at least near the melting point of the materials of which components 12, 24 are made. In the depicted exemplary embodiment, first component 12 is part of a blade that with second component 24, namely a blade foot, that is fashioned on the periphery of a disk 26. Disk 26 is what is known as a BLISK rotor. First and second component 12, 24 can be made of different or similar metallic materials. However, it is also possible for first and second component 12, 24 to be made of similar metallic materials and to be manufactured using different manufacturing methods. This relates for example to forged components, to components manufactured by casting methods, to components made of monocrystals, and to components that have been solidified in a directed manner.

In addition, it will be seen that an insulator 28 is situated at least partly between inductor 18 and components 12, 24. Insulator 28 has a layer-type construction. In addition, insulator 28 is made of a material that, due to its specific properties, does not, or does not significantly, prevent the magnetic interaction between inductor 18 and components 12, 14 that are to be joined, or connecting surfaces 20, 22 thereof. Suitable materials include for example glass, in particular high-temperature-resistant quartz glass, a high-temperature-resistance ceramic, or a high-temperature-resistant plastic.

In addition, it will be seen that first component 12 is mounted in a component mount 14. Component mounted 14 serves as a transport device for first component 12. In order to join first component 12 to second component 24, component mount 14 is moved in the direction of the arrow.

The exemplary embodiment makes it clear that device 10 is suitable both for the manufacture and for the repair of components and parts of a gas turbine.

1. A device for carrying out an inductive low-frequency or high-frequency pressure welding method for joining metallic components, in particular components of a gas turbine, comprising: at least one generator and at least one inductor, wherein an insulator is situated at least partly between the inductor and the components, in the area of the sections that are to be joined of the components, the insulator being made of a material that, due to its specific properties, does not, or does not significantly, prevent the magnetic interaction between the inductor and the components that are to be joined, and the insulator being situated at a distance from the inductor and the components, and that the insulator is made of high-temperature-resistant quartz glass.

2. The device as recited in claim 1, characterized in that the insulator is fashioned with a layer-type construction or as a film.

3. The device as recited in claim 1, characterized in that the device has means that enable the inductive low-frequency or high-frequency pressure welding to be carried out in a vacuum or in a protective gas atmosphere.

4. The device as recited in claim 1, characterized in that the frequencies used in the inductive low-frequency or high-frequency pressure welding are selected from a range between 0.05-2.5 MHz.

5. The device as recited in claim 1, characterized in that each said at least one inductor inducing at least two different frequencies.

6. The device as recited in claim 1, characterized in that the first component is a blade or a part of a blade of a rotor in a gas turbine, and the second component is a ring or a disk of the rotor or is a blade foot situated on the periphery of the ring or of the disk.

7. A component manufactured using a device as recited in claim 1, characterized in that the component is a BLING or a BLISK.
